(19) United States
(12) Patent Application Publication
(10) Pub. No.: US 2026/0348201 A1
(43) Pub. Date: Nov. 5, 2026

(54) LOCK FOR A MOTOR VEHICLE

(71) Applicant: Kiekert Aktiengesellschaft, Heiligenhaus (DE)

(72) Inventors: Ömer INAN, Dorsten (DE); Michael SCHOLZ, Essen (DE); Holger SCHIFFER, Meerbusch (DE); Peter SZEGENY, Engelskirchen (DE)

(73) Assignee: Kiekert Aktiengesellschaft, Heiligenhaus (DE)

(21) Appl. No.: 19/482,009

(22) PCT Filed: Apr. 26, 2024
(86) PCT No.: PCT/DE2024/100374

§ 371 Date: Nov. 6, 2025

(30) Foreign Application Priority Data
May 11, 2023 (DE) 10 2023 112 430.7

(51) Int. Cl. E05B 81/14; E05B 81/04; E05B 81/56; E05B 81/68

(52) U.S. Cl. CPC E05B 81/14; E05B 81/04; E05B 81/56; E05B 81/68

(57) ABSTRACT

A lock for a motor vehicle, in particular an electrically actuatable lock, comprising a locking mechanism having a rotary latch and at least one pawl wherein the rotary latch can be engaged at least in a main catch position by means of the pawl, and a further catch element located in the engaging region between the rotary latch and pawl and pivotally mounted in the rotary latch, wherein a position of the pawl can be immediately detected by a switching means.

The invention relates to a lock for a motor vehicle, in particular an electrically actuatable lock, comprising a locking mechanism having a rotary latch and at least one pawl, wherein the rotary latch can be engaged at least in a main catch position by means of the pawl, and a further catch element located in the engaging region between the rotary latch and pawl and pivotally mounted in the rotary latch.

The demands on modern motor vehicles and in particular the demands on safety and comfort with regard to usability are constantly increasing. It is an aim of developers in the automotive industry to provide easy-opening locking systems with high safety for doors, tailgates or hoods for the operator of the motor vehicle. The locking mechanism arranged in the motor vehicle lock has a decisive influence on the opening noise and the haptics when a door or tailgate is opened.

A locking mechanism consists of a rotary latch and at least one pawl, which can be moved into a catch position in conjunction with a generally stationary lock holder. If, consequently, an open locking mechanism is moved relative to a lock holder, the rotary latch moves into a catch position and is finally latched in a locking or catch position by means of the pawl. There are locking mechanisms having one or two catch positions, i.e., a pre-catch position and a main catch position, and there are locking mechanisms that are equipped with one, two or more pawls in order to implement one or two catch positions in the locking mechanism.

The lock holder generally interacts with the locking mechanism of the motor vehicle lock, in particular of a motor vehicle door lock. The lock holder and motor vehicle door lock generally define the motor vehicle door locking means. In conjunction with the locking mechanism in the motor vehicle door lock, the lock holder ensures a secure and reliable closure of the associated motor vehicle door or of a vehicle part movably arranged on the motor vehicle. For this purpose, the lock holder is usually connected to a motor vehicle body, for example a B or C pillar of the associated motor vehicle body. The motor vehicle door lock, on the other hand, is located in the motor vehicle door to be locked. In principle, this can also be reversed.

Due to the primary closing function of the motor vehicle locking means, this is, on the one hand, a particularly safety-relevant component which, on the other hand, is exposed to particular loads in particular in the event of an accident. The safety features are of a multifaceted nature. On the one hand, the locking system must withstand high forces in an accident to ensure that the moving component remains closed, and on the other hand, ease of use must be maintained. Thus, the locking system is subjected to high loads on the one hand, and on the other hand, comfortable operation of the vehicle as a whole must be ensured. Comfort is defined by the sound of the closing or opening mechanism, and safety-related functions also play a crucial role in the development of locking systems.

In order to enable quite opening and closing of a motor vehicle lock, EP 3 870 786 B1 discloses a lock for a motor vehicle, in particular an electrically operable lock, comprising a locking mechanism having a rotary latch and at least one pawl, wherein the rotary latch can be latched at least in a main catch position by means of the pawl, and a further catch element arranged on the rotary latch in the engaging region between the rotary latch and the pawl. The catch element is pivotally mounted in the rotary latch, wherein the catch element and the pawl are each concentric to their bearing points in their engagement area, so that a rolling movement between the catch element and the pawl is possible. The rolling motion between the catch element and the pawl allows for easy and quiet opening of the locking system.

Furthermore, it has become known from DE 10 2008 048 711 A1 that a high level of user comfort with simultaneously lower noise levels can be achieved if the rotary latch is designed in multiple layers. To this end the motor vehicle lock has a rotary latch with a bearing point, comprising a first contour plate with a first locking surface and a further second contour plate with a second locking surface, which are arranged adjacent to each other and form the common bearing point. The joint construction of the bearing point of the two layers of the rotary latch allows for a particularly stable rotary latch to be provided.

Therefore, solutions are known from the prior art that enable quiet operation of the locking mechanism, and furthermore, the strength can be increased by, for example, the use of multiple layers. Another safety feature, which is particularly relevant for motor vehicle locks with a closing aid, is the door gap that forms when the moving component has fallen into a pre-latch position of the locking mechanism. Only when the moving component is in the pre-latch closing position can the closing drive access the locking mechanism and move the moving component, in particular the side door, from the pre-latch closing position to the main latch closing position. A key safety feature here is that the door element can only be pulled closed when there is a door gap of approximately 6 mm, in order to prevent pinching.

From DE 10 2017 101 703 A1 a technique has become known which describes an additional safety aspect in relation to a closing action. A lock for a motor vehicle is disclosed, comprising a locking mechanism consisting of a rotary latch and at least one pawl, a closing device, an electric drive and a torque converter, wherein a variable torque can be set in the closing device by means of the torque converter, and wherein the closing can be achieved at least partially by means of a frictional connection. The proposal is that the pull handle can engage even when the door element is in a closed position of 7 mm, but the closing action is achieved via a frictional connection up to a door gap of 4 mm. This ensures a level of safety that allows the operator of the motor vehicle to interrupt the closing process even with a door gap of 6 or 5 mm by releasing the door element from the frictional connection. The actual form-fit connection for completely moving the door element into the main catch position only occurs from a door gap of 4 mm.

The requirements for a modern motor vehicle lock that meets today's needs must, on the one hand, meet increased comfort requirements, appropriate noise levels, and increased safety requirements. Safety requirements relate to the smaller door gap when closing, noise development, to increase ease of use, and the increased demands in relation to the ever-increasing weight of motor vehicles, for example from the additional batteries installed. This is where the invention comes in.

The object of the invention is to provide an improved motor vehicle lock and, overall, an improved door locking means. In particular, the object of the invention is to provide a motor vehicle lock that is easy to open, quiet and designed for high forces, and with which even small door gaps can be realized when the pull handle engages.

To achieve the object, a lock for a motor vehicle, in particular an electrically actuatable lock, is provided, comprising a locking mechanism having a rotary latch and at least one pawl, wherein the rotary latch can be engaged at least in a main catch position by means of the pawl, and a catch element mounted in the engaging region between the rotary latch and pawl and pivotally mounted in the rotary latch, wherein a position of the pawl can be immediately detected by a switching means. The design of the motor vehicle according to the invention now makes it possible to achieve a direct detection of the pawl. By directly connecting the switching means to the pawl, the position of the pawl can be determined with pinpoint accuracy. This is particularly advantageous because the use of the pivotable catch means allows the catch means to roll, so to speak, in the rotary latch, and the release of the pawl from the catch element only occurs at a time when the main load on the rotary latch has been relieved.

In other words, the rotary latch in the main catch position is under maximum stress from the lock holder and indirectly from the door or flap seal. If the pawl is now moved out of the movement range of the catch means, i.e., the locking mechanism is unlocked, the catch means first pivots out of the main catch position and only releases the pawl when the rotary latch has already moved out of the main load. This has the advantage that, on the one hand, it makes it easier to separate the pawl from the catch element, and on the other hand, the decoupling noise can be reduced. In any case, the timing of the release of the pawl from the rotary latch can be directly determined by the microswitch. It is therefore possible to directly detect the unlocked position of the lock.

Furthermore, the gap can also be varied when tightening, namely in the case where the separate component takes over the pre-latch position. In particular, the use of the pivotally mounted catch element in the rotary latch limits the space available for arranging a pre-catching at the rotary latch. By mounting the catch element, the starting point for the pre-catching is shifted to an area behind the mounting point of the catch element. By using a separate component on the rotary latch, which simultaneously serves to support or fix the catch element, the pre-catching can be arranged on the rotary latch in such a way that even small door gaps can be achieved with the pre-catching. The pre-catching can be formed by the separate component and arranged on the rotary latch in such a way that a door gap of approximately 4 mm can be set. This results in increased safety when closing, increased force absorption through the rotary latch, and reduced noise in the locking mechanism.

According to the invention, when referring to a motor vehicle lock, synonyms such as locking device, lock or door locking means are synonymous with each other. The term “motor vehicle lock” also includes locks that are used in doors, sliding doors, hatches and/or covers in motor vehicles, i.e., wherever components that can be pivoted or moved on the vehicle must be held securely in position. Preferably but not limitingly, the motor vehicle lock according to the invention relates to a side door. Motor vehicle locks of this type comprise a locking mechanism consisting of rotary latch and at least one pawl.

The rotary latch has a fork-shaped opening. This fork-shaped opening allows a lock holder or lock holder bracket or bolt to be received and, in conjunction with the rotary latch, the pawl and the lock holder, ensures that the motor vehicle is securely locked. In the open state, for example of a side door, the rotary latch is in a position where part of the fork-shaped opening can engage with the lock holder. When the door element is closed, this part of the rotary latch engages with the lock holder, thus enabling the rotary latch to rotate about the rotary latch axis, so that this part of the rotary latch can also be referred to as a catch arm. After the rotary latch is turned and locked in the pre-or main catch position, an opening force acts on the rotary latch, which is absorbed by the pawl. This opening force or relative force between the rotary latch and the lock holder is primarily generated by a seal, in this exemplary embodiment the door seal, wherein this relative force acts between the lock holder and the load arm of the rotary latch. The load arm thus absorbs the closing force of the moving component, in this case the side door.

A catch element acts between the rotary latch and the pawl. According to the invention, the catch element is pivotally mounted in the rotary latch and is held by a separate component. The catch element itself is provided with a main catching or a main-catch locking surface, so that when the pawl engages the catch element, the locking mechanism enters the main catch position. When the locking mechanism is opened, the pawl is moved out of engagement with the rotary latch, wherein at the same time the catch element follows the movement of the pawl and the catch element is pivoted. For this purpose, the catch element is pivotally mounted in a bearing surface of the rotary latch. The pawl only releases from the catch element after the catch element has been pivoted. However, at this point, the rotary latch is already relieved of pressure, making it possible to unlock the locking mechanism easily and quietly.

In one embodiment of the invention, the rotary latch is designed in two layers. Advantageously, the component arranged on the rotary latch can extend over the entire surface of the rotary latch and form an additional bearing point for the rotary latch. In this embodiment, additional stability can be introduced into the rotary latch, wherein, in addition to the basic stabilization by the component, an overall increase in the tensile strength of the locking mechanism can be achieved through the planar extension and, in particular, the formation of an additional bearing for the rotary latch. In other words, the rotary trap is formed from two layers.

In the first layer, the catch element is pivotally mounted in a bearing surface, so that the main catch position can be provided through this first layer. The second layer extends over the first layer and also has a catch position, namely the pre-catching. The pre-catching is arranged in the second layer in such a way that, on the one hand, the catch element is held in place by the second layer, and on the other hand, the pre-catching is so far away from the main catching that a minimal gap can be set in the door gap when the pre-catching is reached. In other words, by arranging the pre-catching next to the main catching, a reduced gap dimension can be maintained or set at the beginning of the closing process using the motor vehicle lock according to the invention.

If a first pawl is provided for the main catch position and a second pawl for the pre-catch position, this results in a further embodiment of the invention. The interaction between rotary latch and pawl is supplemented according to the invention and in this embodiment by the fact that two parallel pawls interact with the layers of the rotary latch. In this process, a first pawl interacts with the catch element to form a main catch position of the locking mechanism, and a second pawl interacts with the second layer and with the pre-catching there, so that a pre-catch position can be achieved. Thus, the advantages of reinforced support through the second layer can be combined with the advantage of achieving a small door gap. In the simplest way, the pre-catching can be arranged parallel to the main catching, so that the pre-catching can be formed and arranged independently of the catch element and thus the main catching on the rotary latch.

Furthermore, it can also be advantageous if the first pawl interacts with the catch element and the second pawl can be engaged with the second layer of the rotary latch. The pawl is therefore constructed in two parts or two layers, wherein the two pawls are independently movable but preferably mounted on a common axis. Both pawls are spring-loaded against the rotary latch. Each pawl forms a catch element with the rotary latch, wherein the catch elements, pre-catching and main catching, are arranged parallel to each other, i.e., in parallel planes. The first pawl engages with the catch element, allowing the locking mechanism to engage in the main catch position, as well as enabling the catch element to be unscrewed and released from the first pawl, thus allowing the locking mechanism to be opened easily and quietly. The second pawl, arranged parallel to the first, interacts with the second layer of the rotary latch. By forming the second layer as a separate component and arranging it on the first layer, the pre-catching can be positioned independently of the main latching in the locking mechanism. In particular, this allows a sufficiently secure bearing surface for the catch element to be provided in the first layer, while at the same time the positioning of the pre-catching can be carried out independently of the main catching.

In a further embodiment of the invention, the position of the pawl can be detected by a separate switching means. According to the invention, a separate pawl is provided for each layer of the rotary latch. If each pawl is now equipped separately with a switching means, the main catching and the pre-catching can be detected separately. Each of the two switching means can be used to detect a pawl and its position. Preferably, the switching means is actively engaged when the pre-catch pawl or the main-catch pawl moves out of the pre-catch or main catch position. Preferably, the switching means are unconnected during the installation of the pre-catch pawl as well as the main-catch pawl on the rotary latch. This has the advantage that the switching means are only connected when the lock is open or partially open. This is advantageous because the locking mechanisms are primarily, that is, for the majority of the time, in the closed position, namely when the vehicle is parked or in operation. The switching means are thus connected and the positions of the pawls detected only for opening and closing the door.

Furthermore, it may be advantageous, or constitute a further embodiment of the invention, if the switching means are arranged in parallel planes together with the pawl. Direct detection of the pawl movement can advantageously take place in the plane of the pawls using the simplest design means. The pawl can in each case have a separate control contour that can be engaged with the switching means. The detection in the plane of the pawls is also advantageous because the pawls perform a pivoting movement about a common axis and consequently the pivoting movement of the pawls can be used directly to detect the pawl position. Consequently, a structurally simple and therefore cost-effective design of the motor vehicle lock can be achieved.

Furthermore, it can be advantageous if a control signal for a closing drive can be generated by means of at least one pawl, in particular a pre-catch pawl. When the locking mechanism is open, both pawls have been moved out of the movement range of the rotary latch. The pawls are preferably moved out of the engagement area with the pawl by means of a release lever. For this purpose, the pre-catch pawl is preferably moved, and the main-catch pawl is additionally pivoted using the pre-catch pawl. The pawls are held out of engagement with the rotary latch until the rotary latch has reached its fully open position. In this state, both switching means are actuated, so that the motor vehicle receives a clear signal that the door or flap is in an open state. When the release lever is released, the main-catch pawl and the pre-catch pawl are spring-loaded back into a contact position with the rotary latch. When the rotary latch reaches its pre-catch position, the pre-catch pawl engages in the pre-catch position of the rotary latch and simultaneously the switching means arranged on the pre-catch pawl is released or a switching signal is generated which can be detected by a motor vehicle control system. This signal can be used to activate the closing drive, so that a door or flap can be closed with electric motor assistance. In other words, the closing drive moves the locking mechanism from a pre-catch position to a main catch position.

Advantageously, the switching means are designed as microswitches. The use of microswitches offers a cost-effective and reliable way to detect the positions of the pawls. Particularly in the interaction of rotary latch, catch element and first pawl, it is necessary that precise detection takes place when unlocking the locking mechanism. For this purpose, microswitches, and preferably microswitches with contact tabs, offer a cost-effective and safe way to detect the movement of the first pawl. The second pawl can also preferably interact with a microswitch with a contact tab. The control contour on the pawls can be designed in such a way that a reliable interaction between the microswitch and the pawl can take place. The pawl, or both pawls, can have control contours.

The control contours offer a further advantageous embodiment of the invention, namely when a control contour is provided on the pawl, wherein the control contour can be brought directly into engagement with the switching means.

The direct connection between the switching means and the pawl offers a great advantage, as direct detection takes place, leading to a high level of reliability in the position detection of the pawls.

The invention is explained in more detail below with reference to the accompanying drawings. However, the principle applies that the exemplary embodiment does not limit the invention, but is merely an advantageous design. The features depicted can be implemented individually or in combination with further features of the description as well as the claims individually or in combination.

In the figures:

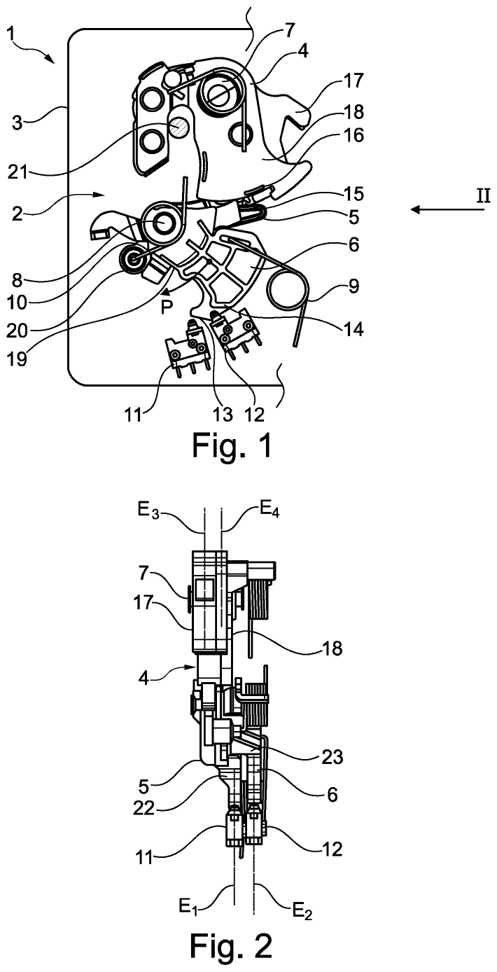

FIG. 1 shows a side view of a motor vehicle lock, only partially depicted, wherein a locking mechanism in a main catch position with a lock case is shown, and

FIG. 2 is a side view of the locking mechanism according to FIG. 1 as seen from arrow Il.

FIG. 1 shows a motor vehicle lock 1 in a side view of a locking mechanism 2, wherein the locking mechanism 2 is rotatably mounted in a lock case 3. The locking mechanism comprises a rotary latch 4 and two pawls 5, 6. The rotary latch 4 and the pawls 5, 6 are each rotatably mounted in the metal lock case 3 via a journal 7, 8. The pawls 5, 6 are each independently movable, wherein the pawls 5, 6 are each spring-loaded in the direction of the rotary latch 4 in the motor vehicle lock 1 by means of a pawl spring 9, 10. The pawls 5, 6 are each assigned to a microswitch 11, 12, meaning that each microswitch 11, 12 acts on one plane of the pawls 5, 6 together with one each of the pawls 5, 6. In particular, the microswitch 11 acts in the first plane of the main pawl 5 and the second microswitch 12 acts on a plane of the pre-catch pawl 6. Control contours 13, 14 are arranged on the pawls 5, 6, wherein the control contours 13, 14 can be brought into engagement with the microswitches 11, 12.

FIG. 1 shows the main catch position of the locking mechanism 2, in which the catch element 15 comes into contact with the main-catch pawl 5. The pre-catch pawl 6 rests against an outer contour 16 of the rotary latch 4, in a spring-loaded manner. The rotary latch 4 comprises two layers 17, 18. The first layer 17 carries the catch element 15 and interacts with the main-catch pawl 5, whereas the second layer 18 interacts with the pre-catch pawl 6.

To open the locking mechanism, the pre-catch pawl 6 is moved clockwise in the direction of the arrow P, specifically until an outer contour 19 of the pre-catch pawl 6 engages with a bolt 20 on the main-catch pawl 5. By means of the pre-catch pawl 6, the main-catch pawl 5 is also moved clockwise in the direction of the arrow P until the main-catch pawl 5 disengages from the catch element 15. The locking mechanism is then unlocked, allowing the rotary latch 4 to move clockwise about the journal 7 and release a lock holder 21. The door or flap can then be opened. The pawls 5, 6 are held disengaged, wherein the pawls 5, 6 are moved, for example, with a release lever, until the rotary latch 4 has moved into the fully open position. The release lever then releases the pawls 5, 6 again, so that the pawls 5, 6 are spring-loaded against the rotary latch 4.

FIG. 2 is a side view of the locking mechanism 2 as shown in FIG. 1 from the perspective of arrow II. FIG. 2 clearly shows that the microswitches 11, 12 are arranged in two different planes E1, E2. The planes E1, E2 are arranged parallel to each other and each contain a microswitch 11, 12 as well as part of the pawls 5, 6. The pawls 5, 6 each have an offset 22, 23, so that the pawls 5, 6 can act in different planes. The rotary latch 4 has a two-layer construction and consists of a first layer 17 and a second layer 18. The first layer 17 extends in the plane E3 and the second layer 18 in the plane E4. Due to the offset 22, 23 in the pawls 5, 6, the pawls 5, 6 are able to detect the movement of the rotary latch 4 and transmit it to the microswitches 11, 12. The pawls 5 and 6 protrude into the planes E3 and E4. The offset 22, 23 provides an advantageous arrangement of the microswitches 11, 12 in the motor vehicle lock 1 and the microswitches 11, 12 can be positioned according to space requirements.

### LIST OF REFERENCE SIGNS

1 Motor vehicle lock
2 Locking mechanism
3 Lock case
4 Rotary latch
5 Main-catch pawl
6 Pre-catch pawl
7,8 Journal
9, 10 Pawl spring
11,12 Microswitch
13,14 Control contour
15 Catch element
16,19 Contour
17 First layer
18 Second layer
20 Bolt
21 Lock holder
22,23 Offset
P Arrow
E1, E2, E3, E4 Plane

1. A lock for a motor vehicle, in particular an electrically actuatable latch, comprising a locking mechanism having a rotary latch and at least one pawl, wherein the rotary latch can be engaged at least in a main catch position by means of the pawl, and a further catch element located in the engaging region between the rotary latch and pawl and pivotally mounted in the rotary latch, wherein position of the pawl can be immediately detected by a switching means.

2. The lock according to claim 1, wherein the rotary latch is designed in two layers.

3. The lock according to claim 1, wherein a first pawl is provided for the main catch position and a second pawl for a pre-catch position.

4. The lock according to claim 1, wherein a position of the pawl can be detected by a separate switching means.

5. The lock according to claim 4, wherein the switching means are arranged in parallel planes with the pawls.

6. The lock according to claim 1, wherein a control signal for a closing drive can be generated by means of at least one pawl, in particular a pre-catch pawl.

7. The lock according to claim 4, wherein the switching means are designed as microswitches.

8. The lock according to claim 1, to 7, wherein a control contour is provided on the pawl, wherein the control contour can be brought directly into engagement with the switching means.

9. The lock according to claim 1, wherein the rotary latch and the pawl are provided with a plastic coating.

10. The lock according to claim 1, wherein the plastic coatings have a different hardness.
